(19) United States
(12) Patent Application Publication
(10) Pub. No.: US 2012/0169787 A1
(43) Pub. Date: Jul. 5, 2012

(54) METHOD AND DEVICE FOR DRIVING PIXEL OF DISPLAY PANEL

(76) Inventor: Yu-Cheng Chen, Hsin-Chu (TW)

(21) Appl. No.: 13/337,151

(22) Filed: Dec. 25, 2011

(30) Foreign Application Priority Data
Dec. 29, 2010 (TW) 099146585

(51) Int. Cl. G09G 5/10

(52) U.S. Cl. 345/690

(57) ABSTRACT

A method for driving a pixel of a panel includes: during a first frame period: generating N different first pixel driving signals according to a first grayscale level; and during N driving time periods included in the first frame period, utilizing different first pixel driving signals in the N first pixel driving signals to orderly drive the pixel, respectively; and during a second frame period: generating N different second pixel driving signals according to a second grayscale level; and during N driving time periods included in the second frame period, utilizing different second pixel driving signals in the N second pixel driving signals to orderly drive the pixel, respectively. A first pixel driving signal of the N first pixel driving signals and a second pixel driving signal of the N second pixel driving signals that correspond to a same driving order have different signal polarities.

### BACKGROUND

1. Technical Field

The disclosed embodiments of the present invention relate to driving a pixel of a display panel, and more particularly, to a driving signal generating technique of a liquid crystal display.

2. Related Art

Liquid crystal displays (LCDs) presently have replaced the traditional cathode ray tube (CRT) displays, and become the main-stream displays on the market. However, due to the inherent limitations of liquid crystal cells, an LCD apparatus still has some imperfections in actual practice. For example, when a viewer looks at the LCD apparatus at different viewing angles, the viewer often gets different visual experiences. This is because that light transmittance of the liquid crystal cells alters along with different viewing angles. Please refer to FIG. 1, which is a schematic diagram of relationship between light transmittance of the liquid crystal cell and the grayscales. As shown in FIG. 1, when the viewer has a front viewing angle (i.e., the viewing angle is zero), the relationship between the light transmittance of the liquid crystal cells and the grayscales is plotted as a curve 110, and when the viewer has an oblique viewing angle (i.e., the viewing angle is 45°, the relationship between the light transmittance of the liquid crystal cells and the grayscales is plotted as a curve 120. As can be known from above, when the viewer has a larger viewing angle, the light transmittance of the liquid crystal cell is higher, and it is particularly evident when it comes to mid grayscale (i.e., 128). Such a change in light transmittance causes the LCD apparatus to have white color washout problem at the oblique viewing angle.

Therefore, how to enhance light transmittance of the liquid crystal cells of the conventional LCDs is an issue needed to be addressed in this field.

### SUMMARY

In accordance with exemplary embodiments of the present invention, a method for generating a pixel driving signal is proposed. The concept is to change polarity of the pixel driving signal during one frame period to avoid the image sticking problem according to the embodiments. In an exemplary embodiment of the present invention, one frame is divided into an odd number of sub-frames, where the odd number is greater than 3; besides, the polarity of the pixel driving signal is changed between different sub-frames.

According to a first aspect/embodiment of the present invention, an exemplary method for driving a pixel of a panel is disclosed. The exemplary method includes: during a first frame period, performing following operations: generating N different first pixel driving signals according to a first grayscale level corresponding to the pixel, wherein N is an integer, and the N first pixel driving signals correspond to a plurality of different sub-grayscales, respectively; and during N driving time periods included in the first frame period, utilizing different first pixel driving signals in the N first pixel driving signals to orderly drive the pixel, respectively; and during a second frame period, performing following operations: generating N different second pixel driving signals according to a second grayscale level corresponding to the pixel, wherein the N second pixel driving signals correspond a plurality of different sub-grayscales, respectively; and during N driving time periods included in the second frame period, utilizing different second pixel driving signals in the N second pixel driving signals to orderly drive the pixel, respectively. A first pixel driving signal of the N first pixel driving signals and a second pixel driving signal of the N second pixel driving signals that correspond to a same driving order have different signal polarities.

According to a second aspect/embodiment of the present invention, an exemplary method for driving a pixel of a panel is disclosed. The pixel has a first sub-pixel and a second sub-pixel. The exemplary method includes: during a first frame period, performing following operations: generating N different first pixel driving signal sets according to a first grayscale corresponding to level the pixel, wherein N is an integer, each of the first pixel driving signal sets includes two different first pixel driving signals, and first pixel driving signals in the N first pixel driving signal sets correspond to a plurality of different sub-grayscales, respectively; and during N driving time periods included in the first frame period, utilizing different first pixel driving signal sets in the N first pixel driving signal sets to orderly drive the first sub-pixel and the second sub-pixel in the pixel, respectively; and during a second frame period, performing following operations: generating N different second pixel driving signal sets according to a second grayscale level corresponding to the pixel, wherein each of the second pixel driving signal sets includes two different second pixel driving signals, and second pixel driving signals in the N second pixel driving signal sets correspond to a plurality of different sub-grayscales, respectively; and during N driving time periods included in the second frame period, utilizing different second pixel driving signal sets in the N second pixel driving signal sets to orderly drive the first sub-pixel and the second sub-pixel in the pixel, respectively. A first pixel driving signal of the N first pixel driving signal sets and a second pixel driving signal of the N second pixel driving signal sets that corresponding to a same driving order have different signal polarities.

According to a third aspect/embodiment of the present invention, an exemplary device for driving a pixel of a panel is disclosed. The exemplary device includes a video processing unit. The video processing unit is for generating N different first pixel driving signals according to a first grayscale level corresponding to the pixel during a first frame period and utilizing different first pixel driving signals in the N first pixel driving signals to orderly drive the pixel during N driving time periods included in the first frame period, respectively, and generating N different second pixel driving signals according to a second grayscale level corresponding to the pixel during a second frame period and utilizing different second pixel driving signals in the N second pixel driving signals to orderly drive the pixel during N driving time periods included in the second frame period, respectively. N is an integer. The N first pixel driving signals and the N second pixel driving signals correspond to a plurality of different sub-grayscales, respectively. A first pixel driving signal of the N first pixel driving signals and a second pixel driving signal of the N second pixel driving signals that correspond to a same driving order have different signal polarities.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of relationship between light transmittance of liquid crystal cell and grayscales.

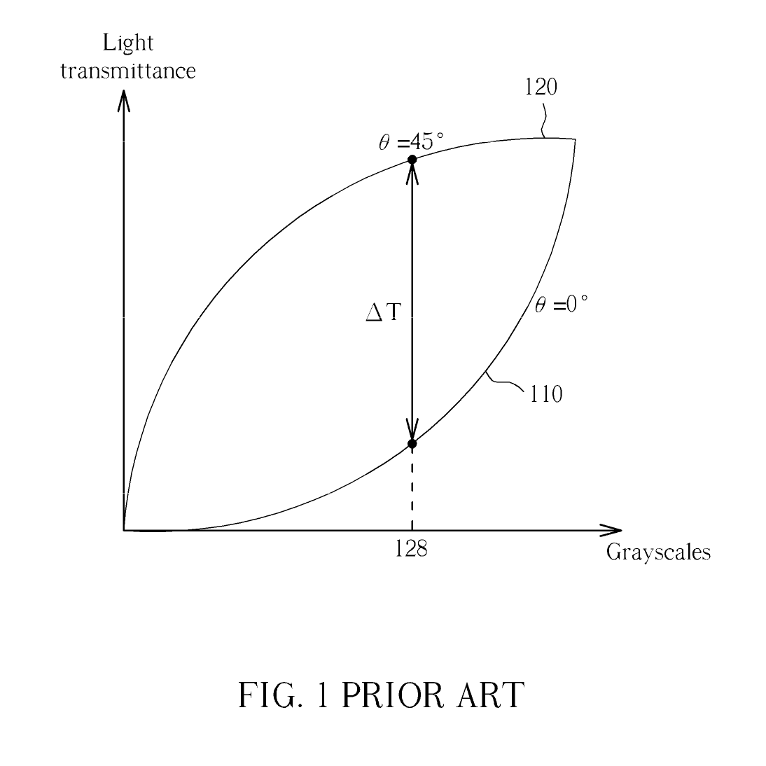

FIG. 2 is a schematic diagram of relationship between signal polarities of pixel driving signals generated by an exemplary method of the present invention.

FIG. 3 is a schematic diagram of relationships between signal polarities of pixel driving signals according to another embodiment of the present invention.

FIG. 4 is a schematic diagram of relationship between signal polarities of pixel driving signals according to yet another embodiment of the present invention.

FIG. 5 is a flowchart of a driving method corresponding to a single pixel according to an embodiment of the present invention.

FIG. 6 is a flowchart of a driving method corresponding to a single pixel including two sub-pixels according to another embodiment of the present invention.

FIG. 7 is a block diagram illustrating a device for driving a pixel of a panel according to an exemplary embodiment of the present invention.

### DETAILED DESCRIPTION

In the following contexts, the concept of the present invention is illustrated with reference to different exemplary embodiments and relevant figures. Moreover, different technical features mentioned in different exemplary embodiments are not limited to the exemplary embodiments only. In fact, in a reasonable scope of the present invention, one of the exemplary embodiments may be properly modified to have specific technical features of other exemplary embodiments.

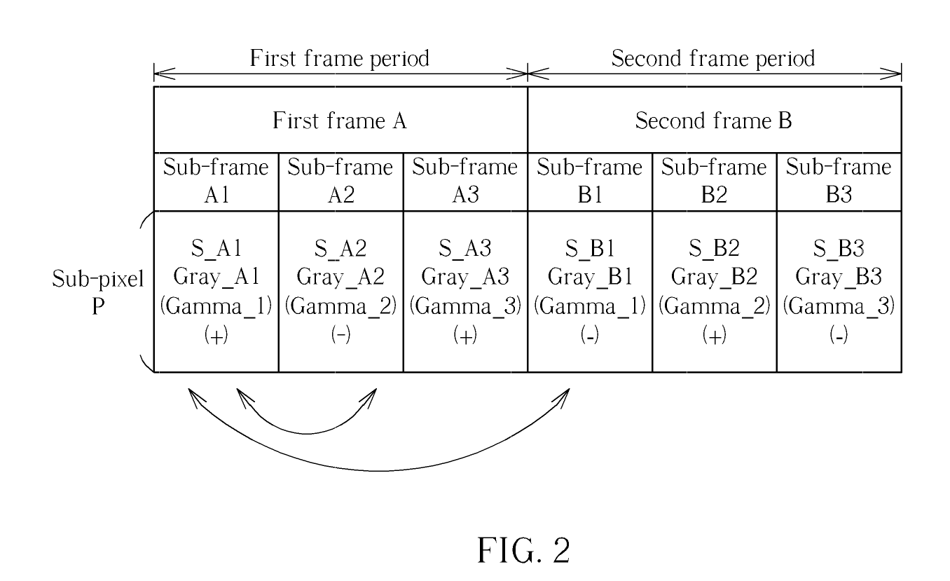

Please refer to FIG. 2, which is a schematic diagram of relationship between signal polarities of pixel driving signals generated by an exemplary method of the present invention. As shown in the figure, a frame period TA of a first frame A includes N driving time periods respectively corresponding to N sub-frames A1-AN. Preferably, the number N is an odd number greater than or equal to 3. For clarity and simplicity, FIG. 2 illustrates the concept of the present invention under an exemplary condition where N=3. Please note that, it is not meant to be a limitation of the present invention.

When the first frame A is displayed, a pixel P is driven according to the corresponding original grayscale level, i.e., Gray_A which can be any one of the R, G, B color components. As mentioned above, in order to solve the color washout problem happening at the oblique viewing angle, the actual driving operation of the pixel P refers to the original grayscale level Gray_A to generate a plurality of different sub-grayscales Gray_A1-Gray_A3 respectively determined based on the gamma curves of the corresponding gamma values Gamma_1, Gamma_2 and Gamma_3, where gamma values Gamma_1, Gamma_2 and Gamma_3 may be totally different from one another or partially different. During different driving time periods TA1-TA3, the pixel P is driven by utilizing pixel driving signals S_A1, S_A2 and S_A3 respectively corresponding to sub-grayscales Gray_A1-Gray_A3. Moreover, the sub-grayscale Gray_A1 has the largest value, the sub-grayscale Gray_A2 has the second largest value, and the sub-grayscale Gray_A3 has the smallest value. As shown in FIG. 2, the signal polarities of the pixel driving signals S_A1, S_A2 and S_A3 are positive, negative and positive, respectively.

Furthermore, when a second frame B is displayed, the pixel P is similarly driven according to the original grayscale level Gray_B corresponding to the second frame B, wherein the grayscale level Gray_B can be any one of the R, G, B color components, and a frame period TB of the second frame B includes 3 driving time periods TB1-TB3 respectively corresponding to 3 sub-frame B1-B3.

The actual driving operation of the pixel P refers to the original grayscale level Gray_B to generate a plurality of different sub-grayscales Gray_B1-Gray_B3 respectively determined based on the gamma curves corresponding to the gamma values Gamma_, Gamma_2 and Gamma_3, wherein the gamma values Gamma_1, Gamma_2 and Gamma_3 may be totally different from one another or partially different. During different time periods TB1-TB3, the pixel P is driven by utilizing the pixel driving signals corresponding to the sub-grayscales Gray_B1-Gray_B3. Moreover, the sub-grayscale Gray_B1 has the largest value, the sub-grayscale Gray_B2 has the second largest value, and the sub-grayscale Gray_B3 has the smallest value. As shown in FIG. 2, the signal polarities of the pixel driving signals are negative, positive and negative, respectively.

By using such a signal polarity configuration, the signal polarities of the pixel driving signals may be changed between every two sub-frames of consecutive sub-frames A1, A2 and A3/B1, B2 and B3. In other words, regarding consecutive sub-frames, the signal polarity of the pixel driving signal of the pixel P is continuously changed/switched. For example, during the 3 driving time periods TA1-TA3 respectively corresponding to 3 sub-frames A1, A2 and A3 and included in the first frame period TA of the first frame A, the pixel driving signal S_A1 and the pixel driving signal S_A2 have different polarities, and the pixel driving signal S_A2 and pixel driving signal S_A3 also have different polarities. Similarly, during the 3 driving time periods TB1-TB3 respectively corresponding to 3 sub-frame B1, B2 and B3 and included in the first frame period TB of the second frame B, the pixel driving signal S_B1 and the pixel driving signal S_B2 have different polarities, and the pixel driving signal S_B2 and the pixel driving signal S_B3 also have different polarities.

In addition, the pixel driving signals corresponding to the same driving order also have different polarities. For example, the pixel driving signal S_A1 and the pixel driving signal S_B1 have different polarities, the pixel driving signal S_A2 and the pixel driving signal S_B2 have different polarities, and the pixel driving signal S_A3 and pixel driving signal S_B3 have different polarities. In this way, the pixel driving signals S_A1 and S_B1 corresponding to a larger voltage value and the pixel driving signals S_B3 and S_A3 corresponding to a smaller voltage value will not always correspond to the same signal polarity as the prior art, thereby mitigating the image sticking problem.

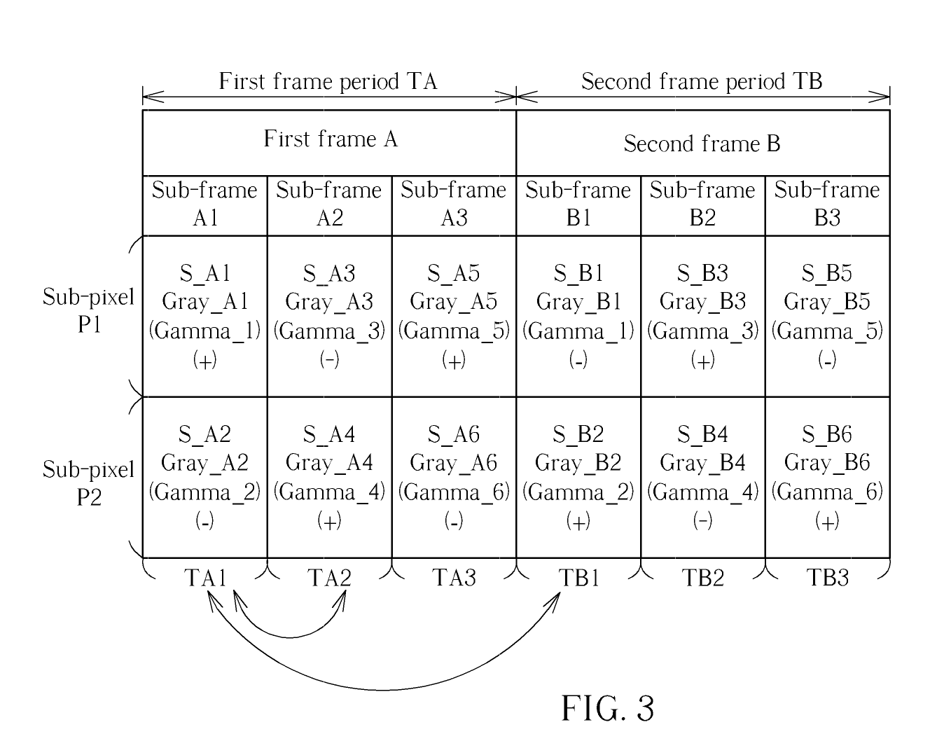

Another embodiment of the present invention provides another method for driving a pixel of a panel, wherein each pixel includes two sub-pixels (e.g., the pixel P includes two sub-pixels P1 and P2). N different pixel driving signal sets are generated during a frame period according to this embodiment, wherein N is an odd number greater than or equal to 3. The technical features of this embodiment will be illustrated in FIG. 3 under a condition where N=3.

When the pixel P is actually driven, the two sub-pixels P1 and P2 of the pixel P would be driven by referring to original grayscale levels Gray_A and Gray_B of the pixel P, wherein the grayscale level Gray_A corresponds to the first frame A, the grayscale level Gray_B corresponds to the second frame B, and the grayscale levels Gray_A and Gray_B can belong to any one of R, G, B color components. As mentioned above, in order to solve color washout problem happening at the oblique viewing angle, the present invention refers to the original grayscale level Gray_A to generate a plurality of different sub-grayscales Gray_A1-Gray_A6 respectively determined based on the corresponding gamma curves of gamma values Gamma_1, Gamma_2, Gamma_3, Gamma_4, Gamma_5 and Gamma_6, wherein the gamma values Gamma_1, Gamma_2, Gamma_3, Gamma_4, Gamma_5 and Gamma_6 may be totally different from one another or partially different. During the different time periods TA1-TA3, sub-pixel P1 and sub-pixel P2 are driven by utilizing the pixel driving signals S_A1-S_A6 corresponding to the sub-grayscales Gray_A1-Gray_A6. Moreover, the sub-grayscale Gray_A1 has the largest value, Gray_A6 has the smallest value, and the rest can be deduced by analogy. The signal polarities are shown in FIG. 3, where during the frame period TA of the first frame A, sub-pixels P1 and P2 of the pixel P are driven by different pixel driving signals S_A1, S_A2, S_A3, S_A4, S_A5, and S_A6 during different time points (e.g., driving time periods TA1-TA3), respectively, wherein the pixel driving signals S_A1, S_A3 and S_A5 are arranged to drive the sub-pixel P1, and the pixel driving signals S_A2, S_A4 and S_A6 are arranged to drive the sub-pixel P2. During the driving time period TA1 corresponding to the sub-frame A1, the pixel driving signal set consisted of the pixel driving signals S_A1 and S_A2 would be used to drive the sub-pixels P1 and P2; during the driving time period TA2 corresponding to the sub-frame A2, the pixel driving signal set consisted of the pixel driving signals S_A3 and S_A4 would be used to drive the sub-pixels P1 and P2; and during the driving time period TA3 corresponding to the sub-frame A3, the pixel driving signal set consisted of the pixel driving signals S_A5 and S_A6 would be used to drive the sub-pixels P1 and P2. Among the pixel driving signal sets, the pixel driving signals corresponding to the same driving order have different signal polarities. For example, the signal polarities of the pixel driving signals S_A1, S_A3 and S_A5 corresponding to the relatively larger sub-grayscales Gray_A1, Gray_A3 and Gray_A5 are positive, negative and positive, respectively, while the signal polarities of the pixel driving signals S_A2, S_A4 and S_A6 corresponding to the relatively smaller sub-grayscales Gray_A2, Gray_A4 and Gray_A6 are negative, positive and negative, respectively. Hence, the pixel driving signal S_A1 and S_A3 have different polarities, and the pixel driving signal S_A3 and S_A5 have different polarities. Furthermore, the pixel driving signal S_A2 and S_A4 have different polarities, and the pixel driving signal S_A4 and S_A6 have different polarities.

Moreover, in the second frame B, the sub-pixels P1 and P2 of the pixel P are also driven according to the corresponding original grayscale level Gray_B. At this moment, multiple different sub-grayscales Gray_B1-Gray_B6 respectively determined based on gamma curves of the corresponding gamma values Gamma_1, Gamma_2, Gamma_3, Gamma_4, Gamma_5 and Gamma_6 would be generated, wherein gamma values Gamma_1, Gamma_2, Gamma_3, Gamma_4, Gamma_5 and Gamma_6 may be totally different from one another or partially different. During different time periods TB1-TB3, the sub-pixel P1 and the sub-pixel P2 are driven by utilizing different pixel driving signals S_B1 -S_B6 corresponding to the sub-grayscale Gray_B1 -Gray_B6, respectively. The sub-grayscale Gray_B1 has the largest value, the sub-grayscale Gray_B6 has the smallest value, and the rest can be deduced by analogy. The signal polarities are shown in the FIG. 3, respectively. As shown in the figure, during the frame period TB of the second frame B, the sub-pixels P1 and P2 of the pixel P are driven by different pixel driving signal sets at different time points (e.g., driving time periods TB1-TB3), wherein the pixel driving signals S_B1, S_B3 and S_B5 are arranged to drive the sub-pixel P1, and the pixel driving signals S_B2, S_B4 and S_B6 are arranged to drive the sub-pixel P2. During the driving time period TB1 corresponding to the sub-frame B1, a pixel driving signal set consisted of the pixel driving signals S_B1 and S_B2 would be used to drive the sub-pixels P1 and P2; during the driving time period TB2 corresponding to the sub-frame B2, a pixel driving signal set consisted of the pixel driving signals S_B3 and S_B4 would be used to drive the sub-pixels P1 and P2; and during the driving time period TB3 corresponding to the sub-frame B3, a pixel driving signal set consisted of the pixel driving signals S_B5 and S_B6 would be used to drive the sub-pixels P1 and P2. Among the pixel driving signal sets, pixel driving signals corresponding to the same driving order have different signal polarities. For example, the signal polarities of the pixel driving signals S_B1, S_B3 and S_B5 corresponding to relatively larger sub-grayscales Gray_B1, Gray_B3 and Gray_B5 are negative, positive and negative, respectively, while the signal polarities of the pixel driving signals S_B2, S_B4 and S_B6 corresponding to relatively smaller sub-grayscales Gray_B2, Gray_B4 and Gray_B6 are positive, negative and positive, respectively. Therefore, the pixel driving signals S_B1 and S_B3 have different polarities, and the pixel driving signals S_B3 and S_B5 have different polarities. The pixel driving signals S_B2 and S_B4 have different polarities, and the pixel driving signals S_B4 and S_B6 have different polarities. Furthermore, between different frames A and B, the pixel driving signal S_A1 an the pixel driving signal S_B1 have different polarities, the pixel driving signal S_A2 and the pixel driving signal S_B2 have different polarities, the pixel driving signal S_A3 and the pixel driving signal S_B3 have different polarities, the pixel driving signal S_A4 and the pixel driving signal S_B4 have different polarities, the pixel driving signal S_A5 and the pixel driving signal S_B5 have different polarities, and the pixel driving signal S_A6 and the pixel driving signal S_B6 have different polarities. In this way, the pixel driving signals S_A1 and S_B1 corresponding to larger voltage values and the pixel driving signal S_B6 and S_A6 corresponding to smaller voltage values will not always correspond to the same signal polarity as the prior art, thereby preventing image sticking from happening.

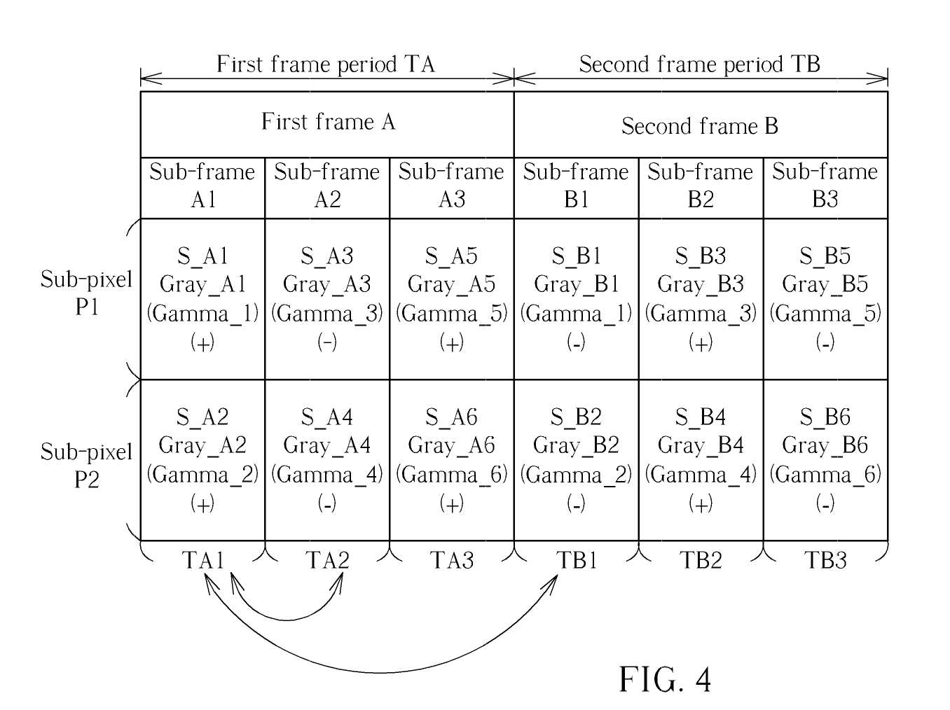

FIG. 4 illustrates relationship between signal polarities of pixel driving signals according to yet another embodiment of the present invention. FIG. 4 is similar to FIG. 3, and the difference is that, in the embodiment shown in FIG. 4, the pixel driving signals driving the sub-pixel P1 and the sub-pixel P2 have the same signal polarity during driving time periods corresponding to the same sub-frame. Moreover, with regard to the frames A and B (or the sub-frames A1 and B1, A2 and B2 and A3 and B3), pixel driving signals corresponding to the same driving order in the pixel driving signal sets have different signal polarities, thereby mitigating the image sticking problem.

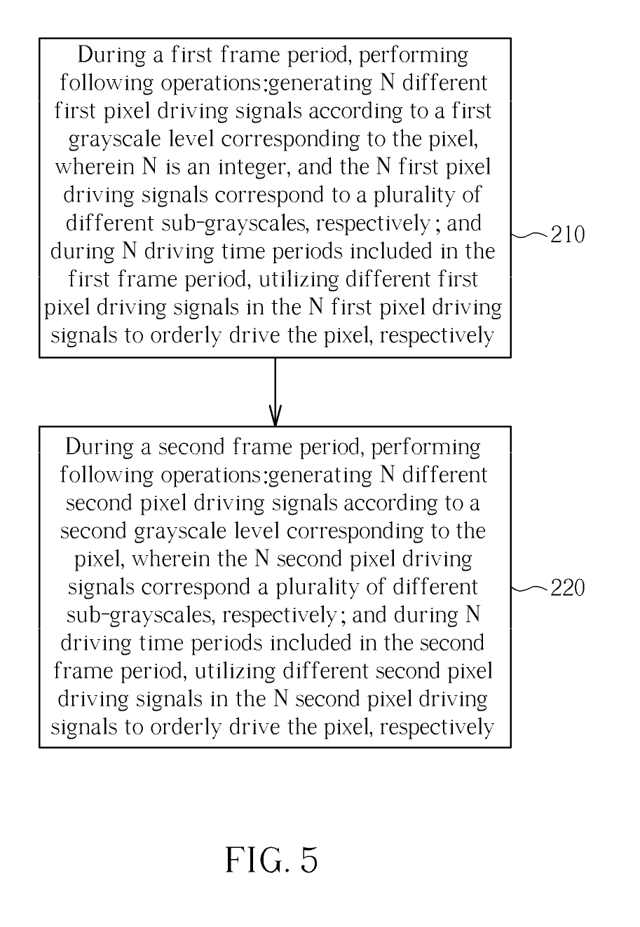

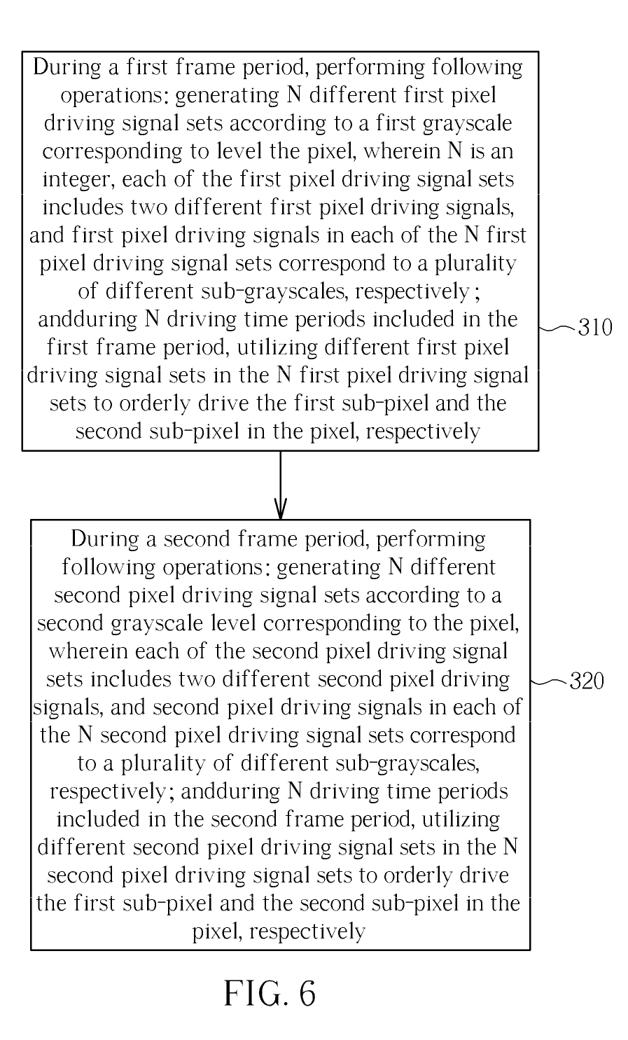

FIG. 5 and FIG. 6 illustrate flowcharts of driving methods according to different embodiments of the present invention, respectively. FIG. 5 is a flowchart of a driving method corresponding to a single pixel. The flowchart includes step 210 and step 220 for generating driving signals required for driving a pixel. In step 210, the present invention method generates N different first pixel driving signals according to a first grayscale level corresponding to the pixel during a first frame period, wherein N is a positive integer, and the N first pixel driving signals correspond to a plurality of different sub-grayscales, respectively. Next, the present invention orderly drives the pixel by utilizing different first pixel driving signals in the N first pixel driving signals during the N driving time periods included in the first frame period, respectively.

Further, in step 220, the present invention generates N different second pixel driving signals according to a second grayscale level corresponding to the pixel during a second frame period, wherein the N second pixel driving signals correspond to a plurality of different sub-grayscales, respectively. Next, the present invention orderly drives the pixel by utilizing different second pixel driving signals in the N second pixel driving signals during the N driving time periods included in the second frame period, respectively. Among the N first pixel driving signals and the N second pixel driving signals, the first and second pixel driving signals corresponding to the same driving order have different signal polarities.

Moreover, FIG. 6 is a flowchart of a driving method corresponding to a single pixel including two sub-pixels. The flowchart includes step 310 and step 320 for generating driving signals required for driving a pixel consisted of a first sub-pixel and a second sub-pixel. In step 310, the present invention generates N different first pixel driving signal sets according to a first grayscale level corresponding to the pixel during a first frame period, wherein N is a positive integer. Each first pixel driving signal set includes two different first pixel driving signals, respectively. In each of the N first pixel driving signal sets, first pixel driving signals correspond to a plurality of different sub-grayscales, respectively. Next, the present invention orderly drives the first sub-pixel and the second sub-pixel of the pixel by utilizing different first pixel driving signal sets in the N first pixel driving signal sets during the N driving time periods included in the first frame period, respectively.

Furthermore, in step 320, the present invention generates N different second pixel driving signal sets according to a second grayscale level corresponding to the pixel during a second frame period, wherein N is a positive integer. Each second pixel driving signal set includes two different second pixel driving signals, respectively. In each of the N second pixel driving signal sets, second pixel driving signals correspond to a plurality of different sub-grayscales, respectively. Next, the present invention orderly drives the second sub-pixel and the second sub-pixel of the pixel by utilizing different second pixel driving signal sets in the N second pixel driving signal sets during the N driving time periods included in the second frame period, respectively. Among the N first pixel driving signal sets and the N second pixel driving signal sets, the first and second pixel driving signals corresponding to the same driving order have different signal polarities.

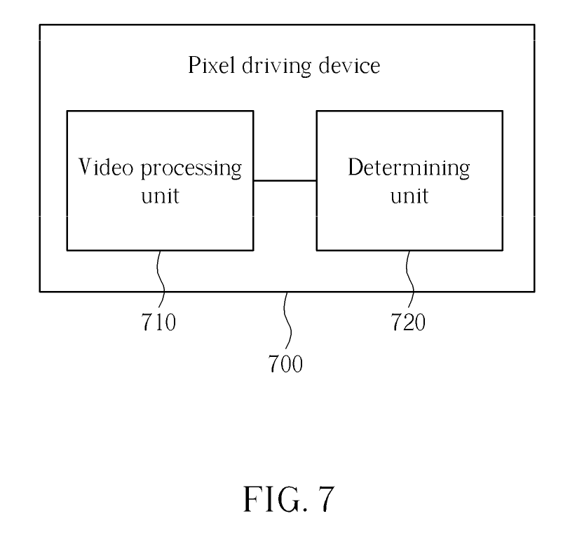

Please refer to FIG. 7, which is a block diagram illustrating a device for driving a pixel of a panel according to an exemplary embodiment of the present invention. The pixel driving device 700 includes, but is not limited to, a video processing unit 710 and a determining unit 720. The exemplary pixel driving method shown in FIG. 5 and FIG. 6 may be employed by the pixel driving device 700. For example, the step 210 and 310 may be executed by the video processing unit 710 during the first frame period TA, and the step 220 and 320 may be executed by the video processing unit 710 during the second frame period TB. The determining unit 720 is coupled to the video processing unit 710 and arranged for determining the plurality of different sub-grayscales corresponding to the N first pixel driving signals according to the first grayscale level and N gamma curves having different gamma values, and determining the plurality of different sub-grayscales corresponding to the N second pixel driving signals according to the second grayscale level and the N gamma curves. As a person skilled in the art should readily understand operations of the pixel driving device 700 after reading above paragraphs, further description is omitted here for brevity.

In conclusion, since the present invention cleverly divides a frame period into odd (e.g., 3 or above) driving time periods, and changes signal polarities of pixel driving signals during different driving time periods, the color washout problem and image sticking problem may be solved in the mean time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for driving a pixel of a panel, comprising:
during a first frame period having N driving time periods, performing following operations:
generating N different first pixel driving signals according to a first grayscale level corresponding to the pixel, wherein N is an integer, and the N first pixel driving signals correspond to a plurality of different sub-grayscales, respectively; and
during the N driving time periods, utilizing different first pixel driving signals in the N first pixel driving signals to orderly drive the pixel, respectively; and
during a second frame period having N driving time periods, performing following operations:
generating N different second pixel driving signals according to a second grayscale level corresponding to the pixel, wherein the N second pixel driving signals correspond a plurality of different sub-grayscales, respectively; and
during the N driving time periods, utilizing different second pixel driving signals in the N second pixel driving signals to orderly drive the pixel, respectively;
wherein a first pixel driving signal of the N first pixel driving signals and a second pixel driving signal of the N second pixel driving signals that correspond to a same driving order have different signal polarities.

2. The method of claim 1, wherein the N driving time periods included in the first frame period includes a first driving time period and a second driving time period that are successive driving time periods; during the first driving time period, the pixel is driven by a first specific pixel driving signal in the N first pixel driving signals; during the second driving time period, the pixel is driven by a second specific pixel driving signal in the N first pixel driving signals; and the first specific pixel driving signal and the second specific pixel driving signal have different signal polarities.

3. The method of claim 1, wherein the N driving time periods included in the second frame period includes a first driving time period and a second driving time period that are successive driving time periods; during the first driving time period, the pixel is driven by a third specific pixel driving signal in the N second pixel driving signals; during the second driving time period, the pixel is driven by a fourth specific pixel driving signal in the N second pixel driving signals; and the third specific pixel driving signal and the fourth specific pixel driving signal have different signal polarities.

4. The method of claim 1, wherein N is an odd number greater than or equal to 3.

5. The method of claim 1, wherein the first frame period and the second frame period are successive frame periods.

6. The method of claim 1, wherein the plurality of different sub-grayscales corresponding to the N first pixel driving signals are determined according to the first grayscale level and N gamma curves having different gamma values;
the plurality of different sub-grayscales corresponding to the N second pixel driving signals are determined according to the second grayscale level and the N gamma curves.

7. A method for driving a pixel of a panel, the pixel having a first sub-pixel and a second sub-pixel, the method comprising:
during a first frame period, performing following operations:
generating N different first pixel driving signal sets according to a first grayscale corresponding to level the pixel, wherein N is an integer, each of the first pixel driving signal sets includes two different first pixel driving signals, and first pixel driving signals in each of the N first pixel driving signal sets correspond to a plurality of different sub-grayscales, respectively; and
during N driving time periods included in the first frame period, utilizing different first pixel driving signal sets in the N first pixel driving signal sets to orderly drive the first sub-pixel and the second sub-pixel in the pixel, respectively; and
during a second frame period, performing following operations:
generating N different second pixel driving signal sets according to a second grayscale level corresponding to the pixel, wherein each of the second pixel driving signal sets includes two different second pixel driving signals, and second pixel driving signals in each of the N second pixel driving signal sets correspond to a plurality of different sub-grayscales, respectively; and
during N driving time periods included in the second frame period, utilizing different second pixel driving signal sets in the N second pixel driving signal sets to orderly drive the first sub-pixel and the second sub-pixel in the pixel, respectively;
wherein, a first pixel driving signal of the N first pixel driving signal sets and a second pixel driving signal of the N second pixel driving signal sets that corresponding to a same driving order have different signal polarities.

8. The method of claim 7, wherein the N driving time periods included in the first frame period include a first driving time period and a second driving time period that are successive time periods; during the first driving time period, the first sub-pixel and the second sub-pixel of the pixel are driven by a first specific pixel driving signal set in the N first pixel driving signal sets; during the second driving time period, the pixel is driven by a second specific pixel driving signal set in the N first pixel driving signal sets; and two different first pixel driving signals included in the first specific driving signal set and two different first pixel driving signals included in the second specific driving signal set have different signal polarities, respectively.

9. The method of claim 7, wherein the N driving time periods included in the second frame period include a first driving time period and a second driving time period that are successive time periods; during the first driving time period, the first sub-pixel and the second sub-pixel of the pixel are driven by a third specific pixel driving signal set in the N second pixel driving signal sets; during the second driving time period, the pixel is driven by a fourth specific pixel driving signal set in the N second pixel driving signal sets; and
two different second pixel driving signals included in the third specific pixel driving signal set and two different second pixel driving signals included in the fourth specific pixel driving signal set have different signal polarities, respectively.

10. The method of claim 7, wherein N is an odd number greater than or equal to 3.

11. The method of claim 7, wherein the first frame period and the second frame period are successive frame periods.

12. The method of claim 7, wherein the different sub-grayscales respectively corresponding to each of the first pixel driving signals in the N first pixel driving signal sets are determined according to the first grayscale level and 2*N gamma curves having different gamma values; the different sub-grayscales respectively corresponding to each of the second pixel driving signals in the N second pixel driving signal sets are determined according to the second grayscale level and 2*N gamma curves.

13. A device for driving a pixel of a panel, comprising:
a video processing unit, for:
during a first frame period having N driving time periods, performing following operations:
generating N different first pixel driving signals according to a first grayscale level corresponding to the pixel, wherein N is an integer, and the N first pixel driving signals correspond to a plurality of different sub-grayscales, respectively; and
during the N driving time periods, utilizing different first pixel driving signals in the N first pixel driving signals to orderly drive the pixel, respectively; and
during a second frame period having N driving time periods, performing following operations:
generating N different second pixel driving signals according to a second grayscale level corresponding to the pixel, wherein the N second pixel driving signals correspond a plurality of different sub-grayscales, respectively; and
during the N driving time periods, utilizing different second pixel driving signals in the N second pixel driving signals to orderly drive the pixel, respectively; wherein a first pixel driving signal of the N first pixel driving signals and a second pixel driving signal of the N second pixel driving signals that correspond to a same driving order have different signal polarities.

14. The device of claim 13, wherein the N driving time periods included in the first frame period includes a first driving time period and a second driving time period that are successive driving time periods; the video processing unit drives the pixel using a first specific pixel driving signal in the N first pixel driving signals during the first driving time period; the video processing unit drives the pixel using a second specific pixel driving signal in the N first pixel driving signals during the second driving time period; and the first specific pixel driving signal and the second specific pixel driving signal have different signal polarities.

15. The device of claim 13, wherein the N driving time periods included in the second frame period includes a first driving time period and a second driving time period that are successive driving time periods; the video processing unit drives the pixel using a third specific pixel driving signal in the N second pixel driving signals during the first driving time period; the video processing unit drives the pixel using a fourth specific pixel driving signal in the N second pixel driving signals during the second driving time period; and the first specific pixel driving signal and the second specific pixel driving signal have different signal polarities.

16. The device of claim 13, wherein N is an odd number greater than or equal to 3.

17. The device of claim 13, wherein the first frame period and the second frame period are successive frame periods.

18. The device of claim 13, further comprising:
a determining unit, coupled to the video processing unit, for determining the plurality of different sub-grayscales corresponding to the N first pixel driving signals according to the first grayscale level and N gamma curves having different gamma values, and determining the plurality of different sub-grayscales corresponding to the N second pixel driving signals according to the second grayscale level and the N gamma curves.
